(19) United States
(12) Patent Application Publication
(10) Pub. No.: US 2017/0349966 A1
(43) Pub. Date: Dec. 7, 2017

(54) QUENCHED-TEMPERED HIGH-STRENGTH STEEL WITH YIELD STRENGTH OF 900 MPA TO 1000 MPA GRADE, AND MANUFACTURING METHOD THEREFOR

(71) Applicant: BAOSHAN IRON & STEEL CO., LTD., Shanghai (CN)

(72) Inventors: Ana Yang, Shanghai (CN); Gang Liu, Shanghai (CN); Wei Wang, Shanghai (CN); Xiaozhen Yang, Shanghai (CN)

(73) Assignee: BAOSHAN IRON & STEEL CO., LTD., Shanghai (CN)

(21) Appl. No.: 15/536,601

(22) PCT Filed: Dec. 8, 2015
(86) PCT No.: PCT/CN2015/096639

§ 371 Date: Jun. 16, 2017

(30) Foreign Application Priority Data
Dec. 19, 2014 (CN) 201410810301.0

(51) Int. Cl. C21D 9/46; C21D 1/18; C22C 38/50; C22C 38/48; C22C 38/46; C21D 6/00; C22C 38/06; C22C 38/02; C22C 38/00; C22C 38/54; C21D 8/02; C22C 38/58; C22C 38/44

(52) U.S. Cl. CPC C21D 9/46; C22C 38/58; C21D 1/18; C22C 38/50; C22C 38/48; C22C 38/46; C22C 38/44; C22C 38/06; C22C 38/02; C22C 38/002; C22C 38/001; C22C 38/54; C21D 8/0247; C21D 8/0226; C21D 8/0205; C21D 6/008; C21D 6/005; C21D 6/004; C21D 2211/008

(57) ABSTRACT

A quenched-tempered high-strength steel having a yield strength of 900-1000 MPa grade and a method of producing the same, with the components and amounts thereof by weight percentage being: C: 0.16-0.20%, Si: 0.10-0.30%, Mn: 0.80-1.60%, Cr: 0.20-0.70%, Mo: 0.10-0.45%, Ni: 0.10-0.50%, Nb: 0.010-0.030%, Ti: 0.010-0.030%, V: 0.010-0.050%, B: 0.0005-0.0030%, Al: 0.02-0.06%, Ca: 0.001-0.004%, N: 0.002-0.005%, P≦0.020%, S≦0.010%, O≦0.008%, and the balance of Fe and unavoidable impurities, and Ceq 0.51-0.60%, Ceq=C+Mn/6+(Cr+Mo+V)/5+(Ni+Cu)/15; 3.7≦Ti/N≦7.0; 1.0≦Ca/S≦3.0; 0.8%≦Mo+0.8Ni+0.4Cr+6V≦1.3%. By using a process of controlling rolling, controlling cooling, and off-line quenching+tempering, a steel sheet produced according to the disclosure has a yield strength of 900-1080 MPa, a tensile strength of 950-1200 MPa, an elongation >10%, and an impact energy at −40° C. >40 J.

### TECHNICAL FIELD

The disclosure relates to a quenched-tempered high-strength steel having a yield strength of 900 MPa-1000 MPa grade and a manufacturing method thereof, wherein the steel has a yield strength of 900-1080 MPa, a tensile strength of 950-1200 MPa, an elongation >10%, an impact energy at −40° C. >40 J, and a microstructure of tempered martensite.

### BACKGROUND ART

The use of a high-strength, easy-to-weld structural steel for manufacture of members of mobile equipments such as beam structures in engineering machinery, crane jibs, dumper bodies and the like can reduce the dead weights of the equipments, reduce fuel consumption, and increase operating efficiency. As the international competition intensifies, it has already become a trend to use a high-strength, easy-to-weld structural steel to manufacture members of mobile equipments such as beam structures in harbor machinery, mining machinery, excavating machinery and loading machinery, crane jibs, dumper bodies and the like. Due to the requirements of high performance, upsizing and light weight in the development of engineering machinery, the strength of the steel for engineering machinery is increased continuously from 500-600 MPa to 700 MPa, 900 MPa, 1000 MPa and even 1100 Mpa in a short period of time. The harsh use environment and load conditions of the ultrahigh-strength steel for engineering machinery impose rigid requirements on the quality of the steel material, including strength, impact resistance, bending property, weldability, strip shape, etc.

At present, there are very few domestic enterprises having the ability of producing high-strength steel sheets having a yield strength of 900-1000 MPa grade. Chinese Patent Application CN102560274A discloses a method for producing a high-strength thick steel sheet having a yield strength of 1000 MPa grade, wherein a process of re-heating-quenching+tempering is employed, and extremely high requirements are imposed on an equipment for decoiling a steel sheet. Chinese Patent Application CN102134680A discloses a method for producing a high-strength steel having a yield strength of 960 MPa grade, wherein a low carbon content and a high Cr content are employed in the design: C: 0.07%-0.09%, Cr: 1.05-1.15%, wherein microalloy elements Nb, Ti, V are absent and Cr has a high content according to this application, which is undesirable for welding. Chinese Patent Application CN101397640A discloses a method for producing a high-strength steel sheet having a yield strength of 960 MPa grade, wherein a high Mo content and a high tempering temperature are employed in the design, wherein the Mo content is 0.45-0.57%, and the tempering temperature is 550-600° C.

The compositional designs in the prior art neither control the comprehensive properties of plasticity and toughness at joints, nor improve strength or toughness of a final steel sheet by controlling inclusions or heredity of microstructure and properties.

### SUMMARY

An object of the disclosure is to provide a quenched-tempered high-strength steel having a yield strength of 900 MPa-1000 MPa grade and a method for manufacturing the same, wherein the high-strength steel has a microstructure of tempered martensite, a yield strength of 900-1080 MPa, a tensile strength of 950-1200 MPa, an elongation >10%, and an impact energy at −40° C. >40 J.

To achieve the above object, the technical solution provided according to the disclosure is as follows:

A quenched-tempered high-strength steel having a yield strength of 900-1000 MPa grade, with the components and amounts thereof by weight percentage being: C: 0.16-0.20%, Si: 0.10-0.30%, Mn: 0.80-1.60%, Cr: 0.20-0.70%, Mo: 0.10-0.45%, Ni: 0.10-0.50%, Nb: 0.010-0.030%, Ti: 0.010-0.030%, V: 0.010-0.050%, B: 0.0005-0.0030%, Al: 0.02-0.06%, Ca: 0.001-0.004%, N: 0.002-0.005%, P≦0.020%, S≦0.010%, O≦0.008%, and the balance of Fe and unavoidable impurities, wherein the above elements meet the following relationships: Ceq 0.51-0.60%, Ceq=C+Mn/6+(Cr+Mo+V)/5+(Ni+Cu)/15; 3.7≦Ti/N≦7.0; 1.0≦Ca/S≦3.0; 0.8%≦Mo+0.8Ni+0.4Cr+6V≦1.3%.

Further, the quenched-tempered high-strength steel having a yield strength of 900 MPa-1000 MPa grade has a yield strength of 900-1080 MPa, a tensile strength of 950-1200 MPa, an elongation >10%, an impact energy at −40° C. >40 J, wherein the steel has a microstructure of tempered martensite.

In the compositional design of the steel according to the disclosure:

Carbon: Carbon has the effect of solid solution strengthening. It regulates the strength, plasticity and toughness of the martensitic structure. As tested, after re-heating and quenching, the tensile strength of low-carbon martensite and the carbon content have the following relationship: Rm=2510C (%)+790 (MPa), wherein Rm is tensile strength. When the carbon content is 0.16% or higher, a tensile strength at a quenched state, which is greater than 1100 MPa can be guaranteed. Then, the strength is further reduced by tempering, so as to improve the toughness. An unduly high amount of carbon will result in increase of the carbon equivalent on the whole, leading to easy cracking during welding. The carbon content according to the disclosure is in the range of 0.16-0.20%.

Silicon: Si in an amount of 0.10% or higher has a good effect of deoxygenation, but red scale tends to occur when the Si content exceeds 0.30%. If the Si content is excessively high, the toughness of the martensitic high-strength steel tends to be degraded. The silicon content according to the disclosure is in the range of 0.10-0.30%.

Manganese: Mn in an amount of 0.8% or higher can increase the hardenability of the steel. When the Mn content exceeds 1.6%, segregation and inclusions such as MnS tend to occur, degrading the toughness of the martensitic high-strength steel. The Mn content according to the disclosure is in the range of 0.80-1.60%.

Chromium: Cr element in an amount of 0.2% or higher can increase the hardenability of the steel, facilitating formation of a full martensitic structure during quenching. At a tempering temperature in the range of about 400-550° C., Cr may form carbides of Cr, and has the effect of resisting softening during medium-temperature tempering. If the Cr content exceeds 0.70%, large sparks will occur during welding, affecting the welding quality. The Cr content according to the disclosure is in the range of 0.20-0.70%.

Molybdenum: Mo element in an amount of 0.10% or higher can increase the hardenability of the steel, facilitating formation of a full martensitic structure during quenching. At a high temperature of 400° C. or higher, Mo can react with C to form compound particles having the effect of resisting softening during high-temperature tempering and softening of welded joints. An excessively high Mo content will lead to increase of the carbon equivalent, degrading weldability. Meanwhile, as Mo is a precious metal, the cost will be increased. The Mo content according to the disclosure is 0.10-0.45%.

Nickel: Ni element in an amount of 0.10% or higher has the effect of refining the martensitic structure and improving the steel toughness. An excessively high content of Ni will lead to increase of the carbon equivalent, degrading weldability. Meanwhile, as Ni is a precious metal, the cost will be increased. The Ni content according to the disclosure is 0.10-0.50%.

Niobium, titanium and vanadium: Nb, Ti and V are microalloy elements which form nano-scale precipitates with C, N and other elements, inhibiting growth of austenite grains during heating. Nb can increase the non-recrystallization critical temperature Tnr and expand the production window. The fine precipitate particles of Ti can improve weldability. V reacts with N and C during tempering to precipitate nano-scale V(C,N) particles, leading to improved steel strength. According to the disclosure, the Nb content is in the range of 0.010-0.030%, the Ti content is in the range of 0.010-0.030%, and the V content is in the range of 0.010-0.050%.

Boron: A trace amount of B can improve the hardenability and strength of the steel. When B exceeds 0.0030%, segregation tends to occur, and borocarbide compounds form, leading to serious degradation of the toughness. The B content according to the disclosure is in the range of 0.0005-0.0030%.

Aluminum: Al is used as a deoxidizer. Addition of 0.02% or more Al to the steel can refine grains and improve the impact toughness. If the Al content exceeds 0.06%, inclusion flaws of Al oxides tend to occur. The Al content according to the disclosure is in the range of 0.02-0.06%.

Calcium: In the smelting of steel, Ca element in an amount of more than 0.001% can act as a purifier to improve the toughness of the steel. If the Ca content exceeds 0.004%, large-size Ca compounds tend to form, which degrades the toughness in turn. The Ca content according to the disclosure is 0.001-0.004%.

Nitrogen: The disclosure requires strict control of the content of N element. In a tempering process, N element having a content of 0.002% or higher can react with V and C to form nano-scale V(C,N) particles, and thus have the effect of precipitation strengthening. In a welding process, softening of a heat-affected zone can also be inhibited by the precipitation strengthening. If the N content exceeds 0.005%, coarse precipitate particles tend to form, leading to degraded toughness. The N content according to the disclosure is 0.002-0.005%.

Phosphorus, sulfur and oxygen: As impurity elements, P, S and O affect steel plasticity and toughness. According to the disclosure, these elements are controlled in the ranges of P≦0.020%, S≦0.010%, O≦0.008%.

The carbon equivalent Ceq of an off-line quenched+tempered high-strength steel having a yield strength of 900-1000 MPa needs to meet: Ceq 0.51-0.60%, Ceq=C+Mn/6+(Cr+Mo+V)/5+(Ni+Cu)/150. If Ceq is too low, softening of welded joints tends to occur; if Ceq is too high, microcracking tends to occur during welding.

According to the disclosure, control of 0.8%≦Mo+0.8Ni+0.4Cr+6V≦1.3% is mainly used to guarantee equal-strength matching welding of the 900-1000 MPa high-strength steel, and adjust the strength and low-temperature toughness of a welding heat affected zone to realize optimal matching with a parent steel sheet in terms of strength and low-temperature toughness. Mo, Ni and Cr elements all can decrease the critical cooling speed of the steel, increase the hardenability of the steel, and increase the strength of the welded joints. Mo reacts with C to form compounds at high temperatures, and it has the effect of resisting softening of the welded joints. Mo and Ni elements both have the effect of refining structures and improving toughness. V and N react to form nano-scale V(C,N) particles which can resist softening of the joints. The collaboration of Mo, Ni, Cr and V elements can regulate the strength and toughness of the welding heat affected zone based on the strength of the parent material. If lower than 0.8%, both the strength and low-temperature toughness of the welded joints will be low; if higher than 1.3%, the strength of the welded joints will be rather high, and thus weld cracking tends to occur.

The control of 3.7≦Ti/N≦7.0 can protect B atoms in the steel, so that B can be solid-dissolved to increase the hardenability. A suitable ratio of Ti to N helps to control the size of Ti precipitate particles, and improve the strength and toughness of the parent material and joints.

Control of 1.0≦Ca/S≦3.0 can spheroidize sulfides in the steel, so as to improve the low-temperature toughness and weldability of the steel.

A method of producing a quenched-tempered high-strength steel having a yield strength of 900-1000 MPa according to the disclosure comprises the following steps:

1) Smelting and Casting of Molten Steel

A composition as described below is smelted in a converter or electrical furnace, refined, and cast to a cast blank, wherein the components and amounts thereof by weight percentage of the composition are: C: 0.16-0.20%, Si: 0.10-0.30%, Mn: 0.80-1.60%, Cr: 0.20-0.70%, Mo: 0.10-0.45%, Ni: 0.10-0.50%, Nb: 0.010-0.030%, Ti: 0.010-0.030%, V: 0.010-0.050%, B: 0.0005-0.0030%, Al: 0.02-0.06%, Ca: 0.001-0.004%, N: 0.002-0.005%, P≦0.020%, S≦0.010%, O≦0.008%, and the balance of Fe and unavoidable impurities, wherein the above elements meet the following relationships:

Ceq0.51-0.60%, Ceq=C+Mn/6+(Cr+Mo+V)/5+(Ni+Cu)/15;

0.8%≦Mo+0.8Ni+0.4Cr+6V≦1.3%; 3.7≦Ti/N≦7.0; 1.0≦Ca/S≦3.0;

2) Heating

The cast blank is heated at 1150-1270° C. in a furnace, wherein, when the temperature of the core of the cast blank arrives at the temperature of the furnace, the temperature is held, and the holding time is >1.5 h;

3) Rolling

The cast blank is rolled to a target thickness by single-stand reciprocating rolling or multi-stand hot continuous rolling, wherein a rolling reduction rate at a final rolling path is >15%; a final rolling temperature is 820-920° C., and the final rolling temperature Tf meets: Ar₃<Tf<Tnr, wherein Ar₃ is a temperature at which hypo-eutectoid steel austenite begins to convert to ferrite: Ar₃=901−325C−92Mn−126Cr−67Ni−149Mo; Tnr is non-recrystallization critical temperature:

Tnr=887+464C+(6445Nb−644sqrt(Nb))+(732V−230sqrt(V))+890Ti+363Al−357Si;

4) Cooling

After the hot rolling, the rolled member is coiled at a temperature in the range of 480-Bs° C., followed by air cooling to room temperature; wherein

Bs=630−45Mn−40V−35Si−30Cr−25Mo−20Ni;

5) Heat Treatment

Quenching: A quenching heating temperature is Ac₃+(30-80°) C, and when the temperature of the core of the steel sheet arrives at the temperature of the furnace, the temperature is held and the holding time is 5-40 min, so as to obtain a full martensitic structure, wherein Ac₃ is a temperature at which transformation of austenite is over,

Ac₃=955−350C−25Mn+51Si+106Nb+100Ti+68Al−11Cr−33Ni−16Cu+67Mo;

wherein the quenching cooling speed is V>e^{(5.3-253C-0.16Si-0.82Mn-0.95Cr-1.7Mo-160B)}° C./s;

Tempering: A tempering temperature is 400-550° C.; when the temperature of the core of the steel sheet arrives at the temperature of the furnace, the temperature is held, and the holding time is 20-180 min, so as to obtain a quenched-tempered high-strength steel having a yield strength of 900-1000 MPa grade.

Further, the quenched-tempered high-strength steel having a yield strength of 900 MPa-1000 MPa grade has a yield strength of 900-1080 MPa, a tensile strength of 950-1200 MPa, an elongation >10%, an impact energy at −40° C. >40 J, wherein the steel has a microstructure of tempered martensite.

In the following relations involved in the present disclosure: Ceq=C+Mn/6+(Cr+Mo+V)/5+(Ni+Cu)/15, Mo+0.8Ni+0.4Cr+6V, Ti/N, Ca/S, the element symbols represent the weight percentages of the corresponding elements. In the following calculation formulae involved in the present disclosure: Ar₃=901−325C−92Mn−126Cr−67Ni−149Mo, Tnr=887+464C+(6445Nb−644sqrt(Nb))+(732V−230sqrt(V))+890Ti+363Al−357Si, Bs=630−45Mn−40V−35 Si−30Cr−25Mo−20Ni, Ac₃=955−350C−25Mn+51Si+106Nb+100Ti+68Al−11Cr−33Ni−16Cu+67Mo, and V>e^{(5.3-2.53C-0.16Si-0.82Mn-0.95Cr-1.87Mo-160B)}, each of the element symbols represents the weight percentage of the corresponding element×100.

In the method for producing a quenched-tempered high-strength steel having a yield strength of 900-1000 MPa grade according to the disclosure, in the process of heating the cast blank, the heating temperature is controlled to be greater than 1150° C., and the holding time of the core is >1.5 h, so that full solid dissolution of the alloy elements can be ensured. If the heating temperature exceeds 1270° C., austenite grains will grow excessively, and thus the inter-grain binding force will be weakened, such that cracking tends to occur during rolling. In addition, if the heating temperature exceeds 1270° C., decarburization tends to occur at the surface of the steel blank, affecting the mechanical properties of the final product.

In order to ensure rolling in an austenite zone, the final rolling temperature is greater than Ar₃; in order to ensure rolling in a non-recrystallization zone of austenite, the final rolling temperature is less than Tnr. Rolling in the non-recrystallization zone of austenite can refine austenite grains and the cooled martensitic structure. After subsequent heat treatment, the grain size and toughness of the steel have some heredity, so that the strength and toughness of the heated steel can be improved. At the same time, rolling at a large reduction rate is conducted to form sufficient deformation energy in the non-recrystallization zone, induce recrystallization of austenite in the range of Ar₃-Tnr, and refine grains.

In the cooling process, coiling is conducted at a temperature in the range of 480-Bs° C. in order to obtain fine bainite structure and improve the steel toughness. After subsequent heat treatment, the grain size and toughness of the steel have some heredity, so that the strength and toughness of the heated steel can be improved.

In the quenching heat treatment process, if the heating temperature is lower than Ac₃+30° C., or the holding time is less than 5 min after the temperature of the core of the steel sheet arrives at the temperature of the furnace, it will be difficult for the alloy to solid dissolve sufficiently. If the heating temperature is higher than Ac₃+80° C., or the holding time is more than 40 min after the temperature of the core of the steel sheet arrives at the temperature of the furnace, austenite grains tend to grow. By controlling the quenching heating temperature and quenching heating time in narrow ranges, obtainment of fine austenite grains can be ensured, so as to refine the martensitic structure after the quenching and improve the strength and toughness of the steel.

In the tempering heat treatment process, for steel of the chemical composition system according to the disclosure, if the tempering temperature exceeds 400° C. and the holding time is 20 min or longer after the temperature of the core of the steel sheet arrives at the temperature of the furnace, oversaturated carbon atoms in the quenched martensite will precipitate to form spherical Fe₃C cementite, and alloy Mo and V will react with C at this temperature to form fine alloy carbides, so as to improve the plasticity and toughness of the steel, and eliminate effectively the internal stress in the steel. If the tempering temperature exceeds 550° C. or the holding time is too long, the spherical Fe₃C cementite and the alloy carbides will be coarsened, which will degrade the toughness of the steel and reduce the strength of the steel.

Optimal matching between the strength and the toughness can be ensured by regulating the tempering temperature and the tempering time.

The beneficial effects of the disclosure include:

By using a process of controlling rolling, controlling cooling, and off-line quenching+tempering, the disclosure makes control with respect to the chemical compositional design, the structure of the parent material, the quenching heating temperature, the tempering heating temperature and the like, so as to obtain good elongation, low-temperature toughness and other properties of the steel while guaranteeing ultrahigh strength.

As compared with the prior art, the disclosure controls the match of strength and toughness between parent material and welded joint by controlling the contents such elements as Mo, Ni, Cr and V, improves the toughness of the parent steel sheet and welded joints by controlling the ratio of Ti to N and the ratio of Ca to S, and improves the strength and toughness of the final steel sheet by a process utilizing the hereditary nature of the structure and properties.

### DESCRIPTION OF THE DRAWINGS

FIG. 1 is an image of the typical metallographical structure of the test steel of Example 1 according to the disclosure;

FIG. 2 is an image of the typical metallographical structure of the test steel of Example 3 according to the disclosure;

FIG. 3 is an image of the typical metallographical structure of the test steel of Example 6 according to the disclosure.

### DETAILED DESCRIPTION

The disclosure will be further illustrated with reference to the following specific Examples.

The process flow for producing the ultrahigh strength steel of the disclosure is as follows: steel making in a converter or electric furnace→secondary refining→continuous casting→heating→rolling→cooling→heat treatment.

A method of producing a quenched-tempered high-strength steel having a yield strength of 900-1000 MPa grade according to Examples 1-10 in the disclosure comprises the following steps:

1) Smelting, casting: A 50 kg vacuum electric furnace was used for smelting. The compositions are shown in Table 1. The smelted liquid steel was cast into cast blanks having a thickness of 120 mm. The cast blanks were placed into an electric furnace for heating.

2) Rolling: The cast blanks were rolled into steel sheets having a target thickness of 10 mm in multiple paths. The final rolling temperature was 820-920° C. At the same time, the final rolling temperature Tf met: Ar₃<Tf<Tnr. The reduction rate at the final path was set at 17%.

3) Cooling: after rolling, the rolled members were subjected to on-line laminar cooling. The final cooling temperature was controlled in the range of 480-Bs° C., wherein Bs was a temperature at which transformation of Bainite began. The rolled members were coiled, and cooled to room temperature.

4) Quenching heat treatment process: In the quenching heat treatment process, the quenching heating temperature was the final temperature of austenitic transformation Ac₃+(30-80°) C; the quenching heating time was 5-40 min after the temperature of the core of the steel sheet arrived at the temperature of the furnace; the quenching cooling speed V>e^{(5.3-2.53C-0.16Si—0.82Mn-0.95Cr-1.87Mo-160B)}° C./s; the steel was quenching cooled to (Ms−150) ° C. or less.

5) Tempering heat treatment process: The tempering temperature was 400-550° C.; the tempering time was 20-180 min after the temperature of the core of the steel sheet arrived at the temperature of the furnace. Then, a quenched-tempered high-strength steel having a yield strength of 900-1000 MPa grade according to the disclosure was obtained.

6) The quenched-tempered steel sheet was subjected to longitudinal tensile testing and longitudinal impact testing.

The specific components and process conditions are shown in Tables 1 and 2. The properties of the sample sheets in the various Examples are shown in Table 3.

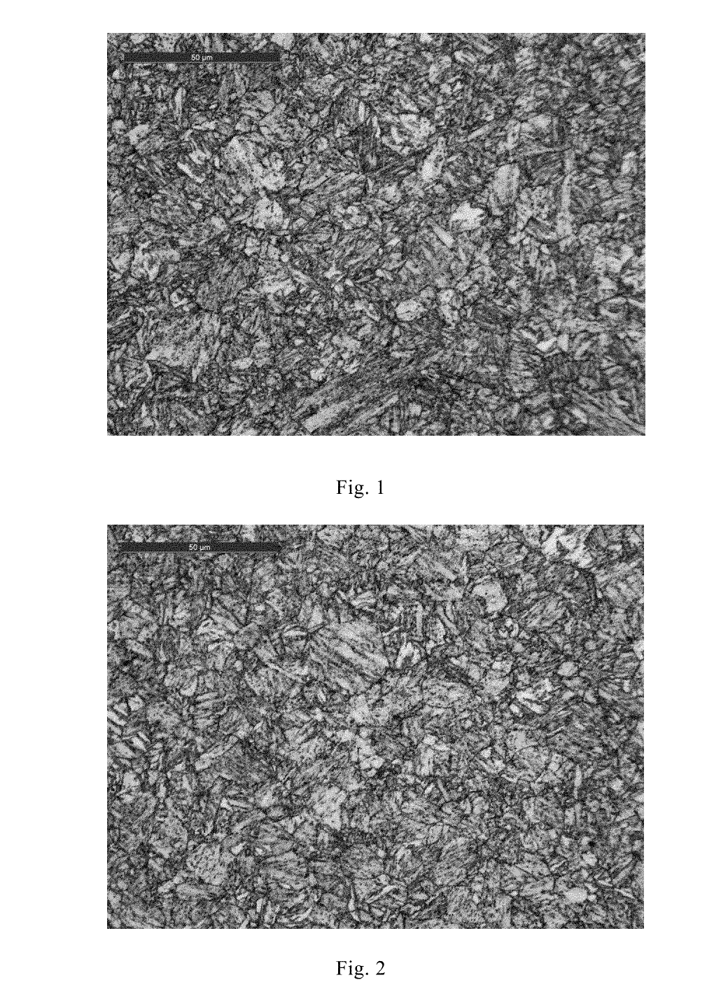

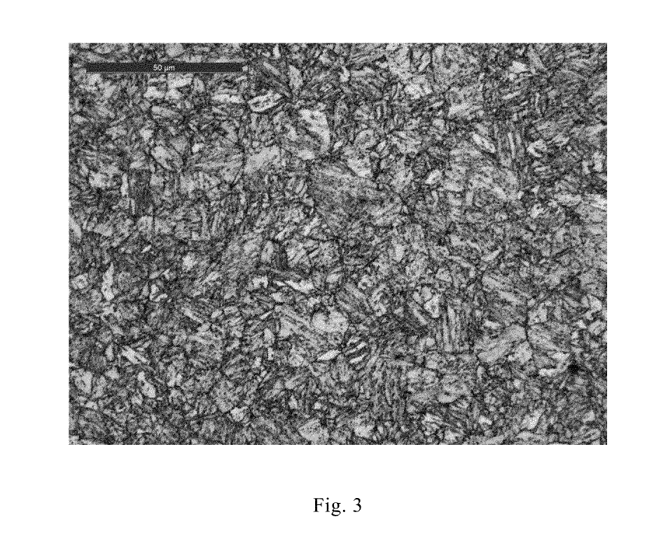

FIGS. 1-3 show the metallographical structure images of the test steels of Examples 1, 3 and 6. As can be seen from the metallographical images in FIGS. 1-3, the metallographical structures of the final steel sheets are homogeneous equiaxed tempered martensite, and the structures are fine.

By using a process of controlling rolling, controlling cooling, and off-line quenching+tempering, the disclosure makes control with respect to the chemical compositional design, the structure of the parent material, the quenching heating temperature, the tempering heating temperature and the like, so as to obtain good elongation, low-temperature toughness and other properties of the steel while guaranteeing ultrahigh strength.

TABLE 1
unit: weight %

| Ex. | C | Si | Mn | Cr | Mo | V | Ni | Nb | Ti | B | Al | Ca | P | S | N | O |
|---|---|---|---|---|---|---|---|---|---|---|---|---|---|---|---|---|
| 1 | 0.16 | 0.27 | 1.21 | 0.7 | 0.22 | 0.022 | 0.37 | 0.01 | 0.011 | 0.0015 | 0.051 | 0.0022 | 0.007 | 0.002 | 0.0021 | 0.0045 |
| 2 | 0.16 | 0.27 | 1.21 | 0.7 | 0.22 | 0.022 | 0.37 | 0.01 | 0.011 | 0.0015 | 0.051 | 0.0022 | 0.007 | 0.002 | 0.0021 | 0.0045 |
| 3 | 0.16 | 0.3 | 1.6 | 0.54 | 0.1 | 0.036 | 0.48 | 0.02 | 0.03 | 0.00052 | 0.06 | 0.0016 | 0.016 | 0.0013 | 0.0045 | 0.0072 |
| 4 | 0.16 | 0.3 | 1.6 | 0.54 | 0.1 | 0.036 | 0.48 | 0.02 | 0.03 | 0.00052 | 0.06 | 0.0016 | 0.016 | 0.0013 | 0.0045 | 0.0072 |
| 5 | 0.19 | 0.14 | 1.03 | 0.2 | 0.45 | 0.01 | 0.27 | 0.03 | 0.02 | 0.0016 | 0.035 | 0.004 | 0.015 | 0.0014 | 0.0036 | 0.0034 |
| 6 | 0.19 | 0.14 | 1.03 | 0.2 | 0.45 | 0.01 | 0.27 | 0.03 | 0.02 | 0.0016 | 0.035 | 0.004 | 0.015 | 0.0014 | 0.0036 | 0.0034 |
| 7 | 0.17 | 0.18 | 1.45 | 0.31 | 0.41 | 0.045 | 0.1 | 0.012 | 0.014 | 0.0017 | 0.022 | 0.0037 | 0.016 | 0.0016 | 0.0037 | 0.0067 |
| 8 | 0.17 | 0.18 | 1.45 | 0.31 | 0.41 | 0.045 | 0.1 | 0.012 | 0.014 | 0.0017 | 0.022 | 0.0037 | 0.016 | 0.0016 | 0.0037 | 0.0067 |
| 9 | 0.2 | 0.1 | 0.8 | 0.65 | 0.32 | 0.05 | 0.5 | 0.018 | 0.015 | 0.003 | 0.026 | 0.0026 | 0.012 | 0.0016 | 0.0026 | 0.0041 |
| 10 | 0.2 | 0.1 | 0.8 | 0.65 | 0.32 | 0.05 | 0.5 | 0.018 | 0.015 | 0.003 | 0.026 | 0.0026 | 0.012 | 0.0016 | 0.0026 | 0.0041 |

TABLE 2

| | | | | Final | | | | Final | | |
|---|---|---|---|---|---|---|---|---|---|---|
| | | | | cooling | | | | cooling | | |
| | Heating | | Final | temperature | Quenching | Quenching | | temperature | Tempering | |
| | Tem- | | rolling | after | heating | holding | Quenching | after | heating | Tempering |
| | perature | Holding | temperature, | rolling, | temperature, | time | cooling | quenching, | temperature, | holding |
| Ex. | ° C. | time, min | ° C. | ° C. | ° C. | min | speed, ° C./s | ° C./s | ° C. | time min |
| 1 | 1250 | 130 | 851 | 493 | 920 | 15 | 26 | 120 | 420 | 80 |
| 2 | 1220 | 160 | 870 | 508 | 910 | 30 | 45 | 212 | 540 | 30 |
| 3 | 1240 | 140 | 866 | 513 | 900 | 20 | 57 | 232 | 430 | 70 |
| 4 | 1260 | 210 | 855 | 517 | 930 | 30 | 46 | 210 | 550 | 20 |
| 5 | 1170 | 100 | 823 | 515 | 960 | 5 | 75 | 64 | 410 | 85 |
| 6 | 1270 | 110 | 891 | 504 | 935 | 40 | 84 | 26 | 500 | 35 |
| 7 | 1210 | 120 | 866 | 506 | 940 | 25 | 35 | 35 | 450 | 65 |
| 8 | 1190 | 190 | 903 | 512 | 950 | 20 | 36 | 153 | 530 | 30 |
| 9 | 1250 | 130 | 876 | 497 | 920 | 15 | 46 | 43 | 400 | 180 |
| 10 | 1230 | 110 | 844 | 513 | 910 | 10 | 64 | 76 | 510 | 30 |

TABLE 3

| | Yield | Tensile | Elongation | Impact energy at −40° C. | | |
|---|---|---|---|---|---|---|
| Ex. | strength MPa | strength MPa | % | (7.5*10*55 mm), J | | |
| 1 | 1015 | 1082 | 13.4 | 88 | 83 | 95 |
| 2 | 917 | 967 | 15.2 | 120 | 103 | 107 |
| 3 | 1057 | 1119 | 12.6 | 53 | 60 | 49 |
| 4 | 983 | 1016 | 14.3 | 87 | 75 | 91 |
| 5 | 1078 | 1121 | 11.8 | 59 | 46 | 68 |
| 6 | 1025 | 1077 | 13.7 | 70 | 85 | 79 |
| 7 | 1006 | 1074 | 14.2 | 110 | 107 | 99 |
| 8 | 942 | 980 | 15.4 | 105 | 122 | 113 |
| 9 | 1074 | 1119 | 12.3 | 63 | 79 | 60 |
| 10 | 1046 | 1097 | 13.1 | 79 | 58 | 88 |

Note:
The test results of the impact energy at −40° C. in the three columns represent the test results of three parallel samples.

What is claimed is:

1. A quenched-tempered high-strength steel having a yield strength of 900-1000 MPa grade, consisting of the following components by weight percentage: C: 0.16-0.20%, Si: 0.10-0.30%, Mn: 0.80-1.60%, Cr: 0.20-0.70%, Mo: 0.10-0.45%, Ni: 0.10-0.50%, Nb: 0.010-0.030%, Ti: 0.010-0.030%, V: 0.010-0.050%, B: 0.0005-0.0030%, Al: 0.02-0.06%, Ca: 0.001-0.004%, N: 0.002-0.005%, P≦0.020%, S≦0.010%, O≦0.008%, the balance of Fe and unavoidable impurities, wherein the above elements meet the following relationships:
Ceq0.51-0.60%, Ceq=C+Mn/6+(Cr+Mo+V)/5+(Ni+Cu)/15;
0.8%≦Mo+0.8Ni+0.4Cr+6V≦1.3%; 3.7≦Ti/N≦7.0; 1.0≦Ca/S≦3.0.

2. The quenched-tempered high-strength steel having a yield strength of 900-1000 MPa grade according to claim 1, wherein the quenched-tempered high-strength steel has a microstructure of tempered martensite.

3. The quenched-tempered high-strength steel having a yield strength of 900-1000 MPa grade according to claim 1, wherein the quenched-tempered high-strength steel has a yield strength of 900-1080 MPa, a tensile strength of 950-1200 MPa, an elongation >10%, and an impact energy at −40° C. >40 J.

4. A method of producing a quenched-tempered high-strength steel having a yield strength of 900-1000 MPa grade, comprising the following steps:
1) Smelting and casting
smelting a composition as described below in a converter or electrical furnace, refining, and casting to a cast blank, wherein the composition consists of the following components by weight percentage: C: 0.16-0.20%, Si: 0.10-0.30%, Mn: 0.80-1.60%, Cr: 0.20-0.70%, Mo: 0.10-0.45%, Ni: 0.10-0.50%, Nb: 0.010-0.030%, Ti: 0.010-0.030%, V: 0.010-0.050%, B: 0.0005-0.0030%, Al: 0.02-0.06%, Ca: 0.001-0.004%, N: 0.002-0.005%, P≦0.020%, S≦0.010%, O≦0.008%, the balance of Fe and unavoidable impurities, wherein the above elements meet the following relationships:
Ceq0.51-0.60%, Ceq=C+Mn/6+(Cr+Mo+V)/5+(Ni+Cu)/15;
0.8%≦Mo+0.8Ni+0.4Cr+6V≦1.3%; 3.7≦Ti/N≦7.0; 1.0≦Ca/S≦3.0;
2) Heating
heating the cast blank at 1150-1270° C. in a furnace, wherein, when the temperature of the core of the cast blank arrives at the temperature of the furnace, the temperature is held, and the holding time is >1.5 h;
3) Rolling
rolling the cast blank to a target thickness by single-stand reciprocating rolling or multi-stand hot continuous rolling, wherein a rolling reduction rate at a final rolling path is >15%; a final rolling temperature is 820-920° C., and the final rolling temperature Tf meets: Ar₃<Tf<Tnr, wherein Ar₃ is a temperature at which hypo-eutectoid steel austenite begins to convert to ferrite, and Tnr is non-recrystallization critical temperature:
Ar₃=901−325C−92Mn−126Cr−67Ni−149Mo;
Tnr=887+464C+(6445Nb−644sqrt(Nb))+(732V−230sqrt(V))+890Ti+363Al−357Si;
4) Cooling
coiling a rolled member at a temperature in the range of 480-Bs° C. after hot rolling, followed by air cooling to room temperature; wherein
Bs=630−45Mn−40V−35Si−30Cr−25Mo−20Ni;
5) Heat treatment
quenching at a quenching heating temperature of Ac₃+(30-80°) C, wherein Ac₃ is a temperature at which transformation of austenite is over:
Ac3=955−350C−25Mn+51Si+106Nb+100Ti+68Al−11Cr−33Ni−16Cu+67Mo;
when a core of a steel sheet arrives at a temperature of the furnace, the temperature is held for a holding time of 5-40 min, so as to obtain a full martensitic structure, wherein Ms is a temperature at which transformation of martensite begins:
Ms=539−423C−30.4Mn−17.7Ni−12.1Cr−11.0Si−7.0Mo;
wherein a quenching cooling speed V>e^{(5.3-2.53C-0.16Si—0.82Mn-0.95Cr-1.87Mo-160B)}° C./s;
tempering at a tempering temperature of 400-550° C.; when the temperature of the core of the steel sheet arrives at the temperature of the furnace, the temperature is held for a holding time of 20-180 min, so as to obtain a quenched-tempered high-strength steel having a yield strength of 900-1000 MPa grade.

5. The method of producing a quenched-tempered high-strength steel having a yield strength of 900-1000 MPa grade according to claim 4, wherein a high-strength steel sheet obtained by said method has a microstructure of tempered martensite.

6. The method of producing a quenched-tempered high-strength steel having a yield strength of 900-1000 MPa grade according to claim 4, wherein a high-strength steel sheet obtained by said method has a yield strength of 900-1080 MPa, a tensile strength of 950-1200 MPa, an elongation >10%, and an impact energy at −40° C. >40 J.
